(19) United States
(12) Patent Application Publication
(10) Pub. No.: US 2003/0181324 A1
(43) Pub. Date: Sep. 25, 2003

(54) Decomposition catalyst for nitrous oxide, prcocess for producing the same and process for decomposing nitrous oxide

(76) Inventors: Masatoshi Hotta, Kanagawa (JP); Yoshio Furuse, Kanagawa (JP); Hitoshi Atobe, Kanagawa (JP); Shigehiro Chaen, Kanagawa (JP); Yasutake Teraoka, Fukuoka (JP)

Correspondence Address: SUGHRUE MION, PLLC, 2100 PENNSYLVANIA AVENUE, N.W., WASHINGTON, DC, 20037, US

(21) Appl. No.: 10/362,880

(22) PCT Filed: Feb. 27, 2002
(86) PCT No.: PCT/JP02/01792

(30) Foreign Application Priority Data
Feb. 28, 2001 (JP) 2001-53261

(51) Int. Cl. B01D 53/56

(52) U.S. Cl. 502/262; 502/261; 502/253; 502/241; 423/239.1

(57) ABSTRACT

To provide a catalyst obtained by loading at least one noble metal selected from the group consisting of rhodium, ruthenium and palladium on a support selected from silica and silica alumina, and a method for decomposing nitrous oxide using the catalyst thereof. The catalyst for decomposing nitrous oxide of the present invention cannot be easily affected by a volatile anesthetic contained in a waste anesthetic gas, can recover the activity by activation and regeneration even when deteriorated, and can reduce the amount of NOₓ generated to less than the allowable concentration.

### CROSS-REFERENCE TO RELATED APPLICATION

This application is based on the provisions of 35 U.S.C. Article 111(a) with claiming the benefit of filing dates of U.S. provisional applications Serial No. 60/275,107 filed on Mar. 13, 2001, under the provisions of 35 U.S.C. 111(b), pursuant to 35 U.S.C. Article 119(e) (1).

### TECHNICAL FIELD

The present invention relates to a catalyst for decomposing nitrous oxide contained in a waste anesthetic gas discharged from an operating room, and also relates to a process for producing the catalyst and a method for decomposing nitrous oxide using the catalyst.

### BACKGROUND ART

An anesthetic gas contains nitrous oxide and a volatile anesthetic. Since 1960, contamination of an operating room by the anesthetic gas and adverse effects of the anesthetic gas on the health of workers in the operating room have been taken as a matter of issue and it is now known that the long-term inhalation of the anesthetic gas leaked out in the operating room causes disorder of the health. In the U.S.A., the National Institute for Occupational Safety and Health (NIOSH) recommends to reduce, as a permissible standard, nitrous oxide (N₂O) to 25 ppm or less and a volatile anesthetic to 2 ppm on the sole use and to 0.5 ppm or less on use in combination with nitrous oxide. To follow this recommendation, all anesthesia machines must be equipped with a waste anesthetic gas-removing apparatus and at the present time, the environment in the operating room can almost reach the above-described levels.

An anesthetic gas usually contains nitrous oxide and from about 2 to 3% of a volatile anesthetic. Among volatile anesthetics, volatile anesthetics in particular containing chlorine within the molecule are known to have a possibility of destroying the ozone layer. Also, in recent years, the global environmental issue is high-lighted and at the International Global Warming Conference (in the third session of the Conference of the parties; COP3), nitrous oxide is, as well as nitrogen dioxide, methane and chlorofluorocarbon, particularly taken notice of as a global scale environmental pollutant which brings about destruction of the ozone layer in the stratosphere or elevation of the temperature due to greenhouse effect (the global warming effect is about 300 times as high as the carbon dioxide).

The waste anesthetic gas-removing apparatus is an apparatus for discharging the waste anesthetic gas outdoors from the exhalation of a patient by letting a compression air or the like to accompany the gas. However, the gas discharged from each operating room by the waste anesthetic gas-removing apparatus is released into the atmosphere without passing through any treatment at the present time. From the reasons described above, this technique which may improve the environment within the operating room is disadvantageous from the standpoint of improving the global environmental issue taken as a problem in recent years. In view of the global environment protection, the waste anesthetic gas should not be released into the atmosphere as it is but both nitrous oxide and volatile anesthetic contained in the waste anesthetic gas discharged from the waste anesthetic gas-removing apparatus must be removed or rendered harmless.

The volatile anesthetic mixed with nitrous oxide has been heretofore halothane (1,1,1-trifluoro-2-bromo-2-chloroethane) but in recent years, fluoro ethers such as isoflurane (1-chloro-2,2,2-trifluoroethyl difluoromethyl ether) and sevoflurane (fluoromethyl-2,2,2-trifluoro-1-(trifluoromethyl) ethyl ether) are predominantly used. On use of these volatile anesthetics, oxygen is fed to an anesthesia machine where a volatile anesthetic is filled to occupy 2 to 3% in an anesthetic gas, and a vapor pressure portion of the volatile anesthetic is mixed with nitrous oxide.

As for conventional techniques for treating a waste anesthetic gas, a method of integrating an activated carbon canister or the like into the waste anesthetic gas-removing apparatus to remove, for example, halothane as a volatile anesthetic and then, decomposing nitrous oxide using a catalyst is known.

Known examples of the catalyst for decomposing nitrous oxide contained in the waste anesthetic gas include:

(1) a catalyst mainly comprising at least one noble metal selected from the group consisting of platinum, palladium, rhodium, iridium and ruthenium (see, JP-B-61-45486 (the term “JP-B” as used herein means an “examined Japanese patent publication”));

(2) a catalyst containing an iron family metal and an oxide of a rare earth element or additionally containing at least one metal of the platinum family (see, JP-B-61-45487);

(3) a catalyst mainly comprising a mixture of cupric oxide and chromium oxide or additionally containing at least one oxide selected from the group consisting of ferric oxide, nickel oxide, cobalt oxide and manganese dioxide (see, U.S. Pat. No. 4,259,303(JP-B-61-50650, JP-B-62-27844)); and

(4) a catalyst mainly comprising at least one of ferric oxide and chromium oxide (see, JP-B-62-27844).

According to the method for decomposing nitrous oxide using the catalyst described in (1) to (4) above, nitrous oxide in a high concentration may be decomposed, however, it is reported that the catalyst is some or less poisoned by the halothane. In recent years, fluoroether-type volatile anesthetics such as isoflurane (1-chloro-2,2,2-trifluoroethyl difluoromethyl ether) and sevoflurane (fluoromethyl-2,2,2-trifluoro-1-(trifluoromethyl) ethyl ether) are used, and sevoflurane in particular readily decomposes as compared with halothane and therefore, even the catalyst (3) which is relatively less poisoned by halothane is poisoned. Thus, catalysts known at present cannot be evaded from the poisoning by fluoroethers.

According to the method for decomposing nitrous oxide using the catalyst described in (2) to (4) above, nitrous oxide in a high concentration may be decomposed but nitrogen monoxide (NO) and nitrogen dioxide (NO₂) (hereinafter collectively referred to as “NOx”) as nitrogen oxides are produced in an amount of 5 to 32 ppm and this disadvantageously results in the generation of NOx in excess of the allowable concentration of 3 ppm (TWA, time weighted average) for NO₂. According to the method for decomposing nitrous oxide using the catalyst described in (1), when moisture in an amount of, for example, approximately from 1 to 3% is present in the reaction gas, the catalyst may decrease in the activity and this remains as a problem to be solved.

The nitrous oxide-containing waste anesthetic gas discharged from an operating room differs from the nitrous oxide-containing exhaust gas discharged from factories or incineration facilities in the following points: firstly, the concentration of nitrous oxide contained in the waste anesthetic gas is very high of 20 to 50% and secondly, the waste anesthetic gas contains a volatile anesthetic gas. Particularly, when a waste anesthetic gas having mixed therein a volatile anesthetic is fed as it is to the catalyst for decomposing nitrous oxide as described above, this sometimes incurs decrease in the specific surface area of the catalyst for decomposing nitrous oxide, as a result, the catalytic activity is seriously reduced. Although it is preferred for maintaining the activity of the catalyst for decomposing nitrous oxide to remove the volatile anesthetic as much as possible, demands are being made to develop a catalyst capable of being less poisoned and free from deterioration in the activity even when the volatile anesthetic flows into the catalyst layer.

### DISCLOSURE OF INVENTION

The present invention has been made under these circumstances and the object of the present invention is to provide a catalyst for decomposing nitrous oxide contained in a waste anesthetic gas discharged from an operating room. Particularly, the object of the present invention is to provide a catalyst for decomposing nitrous oxide, which cannot be easily affected by a volatile anesthetic contained in a waste anesthetic gas, which can recover the activity by activation and regeneration even when deteriorated, and which can reduce the amount of NOx generated to less than the allowable concentration. The object of the present invention includes providing a process for producing the catalyst and a method for decomposing nitrous oxide using the catalyst.

As a result of extensive investigations to solve the above-described problems, the present inventors have found that these problems can be solved by using any one of the following catalysts (1) to (3):

(1) a catalyst obtained by loading at least one noble metal selected from the group (a) consisting of rhodium, ruthenium and palladium on a support selected from silica and silica alumina,

(2) a catalyst obtained by loading at least one noble metal selected from the group (a) consisting of rhodium, ruthenium and palladium, (b) aluminum and at least one metal selected from the group (c) consisting of zinc, iron and manganese on a silica support, and

(3) a catalyst obtained by loading at least one noble metal selected from the group (a) consisting of rhodium, ruthenium and palladium and at least one metal selected from the group (d) consisting of magnesium, zinc, iron and manganese on a silica alumina support. The present invention has been accomplished based on this finding.

The present invention relates to a catalyst for decomposing nitrous oxide as described in [1] to [10], a process for producing a catalyst for decomposing nitrous oxide as described in [111 and [12], a method for decomposing nitrous oxide as described in [13] to [24] as follows.

[1] A catalyst for decomposing nitrous oxide, comprising a support and supported thereon at least one noble metal selected from the group consisting of rhodium, ruthenium and palladium, the support comprising silica or silica alumina.

[2] A catalyst for decomposing nitrous oxide, comprising a support and supported thereon:

(a) at least one noble metal selected from the group consisting of rhodium, ruthenium and palladium,

(b) aluminum, and

(c) at least one metal selected from the group consisting of zinc, iron and manganese,

the support comprising silica.

[3] The catalyst for decomposing nitrous oxide as described in [2] above, wherein at least one metal selected from the group (c) consisting of zinc, iron and manganese is contained in an amount of 0.1 to 5.0% by mass based on the entire mass of the catalyst.

[4] The catalyst for decomposing nitrous oxide as described in [2] above, wherein aluminum is contained in an atomic ratio of 2 or more to at least one metal selected from the group (c) consisting of zinc, iron and manganese.

[5] The catalyst for decomposing nitrous oxide as described in [2] or [4] above, wherein at least a part of aluminum forms a spinel crystalline composite oxide with at least one metal selected from the group (c) consisting of zinc, iron and manganese.

[6] A catalyst for decomposing nitrous oxide, comprising a support and supported thereon:

(a) at least one noble metal selected from the group consisting of rhodium, ruthenium and palladium, and

(d) at least one metal selected from the group consisting of magnesium, zinc, iron and manganese, the support comprising silica alumina.

[7] The catalyst for decomposing nitrous oxide as described in [6] above, wherein at least one metal selected from the group (d) consisting of magnesium, zinc, iron and manganese is contained in an amount of 0.1 to 5.0% by mass based on the entire mass of the catalyst.

[8] The catalyst for decomposing nitrous oxide as described in [6] above, wherein aluminum is contained in an atomic ratio of 2 or more to at least one metal selected from the group (d) consisting of magnesium, zinc, iron and manganese.

[9] The catalyst for decomposing nitrous oxide as described in [6] or [8] above, wherein at least a part of aluminum forms a spinel crystalline composite oxide with at least one metal selected from the group (d) consisting of magnesium, zinc, iron and manganese.

[10] The catalyst for decomposing nitrous oxide as described in any one of [1], [2] or [6] above, wherein the noble metal is contained in an amount of 0.05 to 10% by mass based on the entire mass of the catalyst.

[11] A process for producing a catalyst for decomposing nitrous oxide, comprising the following three steps:

(1) a step of loading aluminum (b) and at least one metal selected from the group (c) consisting of zinc, iron and manganese on a support comprising silica;

(2) a step of calcining the support obtained in the step (1) at 400 to 900° C.; and

(3) a step of loading at least one noble metal selected from the group (a) consisting of rhodium, ruthenium and palladium on the calcined support obtained in the step (2).

[12] A process for producing a catalyst for decomposing nitrous oxide, comprising the following three steps:

(1) a step of loading at least one metal selected from the group (d) consisting of magnesium, zinc, iron and manganese on a support comprising silica alumina;

(2) a step of calcining the support obtained in the step (1) at 400 to 900° C.; and

(3) a step of loading at least one noble metal selected from the group (a) consisting of rhodium, ruthenium and palladium on the calcined support obtained in the step (2).

[13] A method for decomposing nitrous oxide, comprising contacting the catalyst for decomposing nitrous oxide described in any one of [1], [2] or [6] above with a nitrous oxide-containing gas at 200 to 600° C.

[14] A method for decomposing nitrous oxide, comprising decomposing nitrous oxide using a catalyst, wherein the catalyst is a catalyst comprising a support and supported thereon at least one noble metal selected from the group consisting of rhodium, ruthenium and palladium and the support comprises silica or silica alumina and wherein a nitrous oxide-containing gas is contacted with the catalyst at 200 to 600° C., the feeding of nitrous oxide-containing gas is stopped on recognizing the reduction in activity of the catalyst in the decomposition process, the catalyst is activated and regenerated by heating at 500 to 900° C. and then the feeding of nitrous oxide-containing gas is restarted.

[15] A method for decomposing nitrous oxide, comprising decomposing nitrous oxide using a catalyst, wherein the catalyst is a catalyst comprising a support and supported thereon:

(a) at least one noble metal selected from the group consisting of rhodium, ruthenium and palladium,

(b) aluminum, and

(c) at least one metal selected from the group consisting of zinc, iron and manganese,

and the support is silica and wherein a nitrous oxide-containing gas is contacted with the catalyst at 200 to 600° C., the feeding of nitrous oxide-containing gas is stopped on recognizing the reduction in activity of the catalyst in the decomposition process, the catalyst is activated and regenerated by heating at 500 to 900° C. and then the feeding of nitrous oxide-containing gas is restarted.

[16] The method for decomposing nitrous oxide as described in [15] above, wherein the catalyst contains at least one metal selected from the group (c) consisting of zinc, iron and manganese in an amount of 0.1 to 5.0% by mass based on the entire mass of the catalyst.

[17] The method for decomposing nitrous oxide as described in [15] above, wherein the catalyst contains aluminum in an atomic ratio of 2 or more to at least one metal selected from the group (c) consisting of zinc, iron and manganese.

[18] The method for decomposing nitrous oxide as described in [15] or [17] above, wherein at least a part of aluminum contained in the catalyst forms a spinel crystalline composite oxide with at least one metal selected from the group (c) consisting of zinc, iron and manganese.

[19] A method for decomposing nitrous oxide, comprising decomposing nitrous oxide using a catalyst] above, wherein the catalyst is a catalyst comprising a support and supported thereon:

(a) at least one noble metal selected from the group consisting of rhodium, ruthenium and palladium, and

(d) at least one metal selected from the group consisting of magnesium, zinc, iron and manganese, and the support is silica alumina and wherein a nitrous oxide-containing gas is contacted with the catalyst at 200 to 600° C., the feeding of nitrous oxide-containing gas is stopped on recognizing the reduction in activity of the catalyst in the decomposition process, the catalyst is activated and regenerated by heating at 500 to 900° C. and then the feeding of nitrous oxide-containing gas is restarted.

[20] The method for decomposing nitrous oxide as described in [19] above, wherein the catalyst contains at least one metal selected from the group (d) consisting of magnesium, zinc, iron and manganese in an amount of 0.1 to 5.0% by mass based on the entire mass of the catalyst.

[21] The method for decomposing nitrous oxide as described in [19] above, wherein the catalyst contains aluminum in an atomic ratio of 2 or more to at least one metal selected from the group (d) consisting of magnesium, zinc, iron and manganese.

[22] The method for decomposing nitrous oxide as described in [19] or [21] above, wherein at least a part of aluminum contained in the catalyst forms a spinel crystalline composite oxide with at least one metal selected from the group (d) consisting of magnesium, zinc, iron and manganese.

[23] The method for decomposing nitrous oxide as described in any one of [14], [15] or [19] above, wherein the catalyst contains the noble metal in an amount of 0.05 to 10% by mass based on the entire mass of the catalyst.

[24] The method for decomposing nitrous oxide as described in any one of [14], [15] or [19] above, wherein the nitrous oxide-containing gas contains a volatile anesthetic.

### BRIEF DESCRIPTION OF DRAWINGS

FIG. 1 shows the relationship between the temperature and the decomposition ratio of nitrous oxide in Reaction Example 1.

FIG. 2 shows the relationship between the temperature and the decomposition ratio of nitrous oxide in Reaction Example 2.

FIG. 3 shows the relationship between the temperature and the decomposition ratio of nitrous oxide in Reaction Example 3.

FIG. 4 shows the relationship between the temperature and the decomposition ratio of nitrous oxide in Comparative Reaction Example 1.

FIG. 5 shows the relationship between the temperature and the decomposition ratio of nitrous oxide in Comparative Reaction Example 2.

### DETAILED DESCRIPTION OF THE INVENTION

The present invention is described in detail below.

The catalyst for decomposing nitrous oxide of the present invention is a catalyst capable of decomposing nitrous oxide having a concentration over the range from low to high. The nitrous oxide contained in a waste anesthetic gas discharged from an operating room is somewhat diluted with compressed air. But it still has a very high concentration of 70% or less. However, the catalyst for decomposing nitrous oxide of the present invention can cope with this high concentration.

Also, the catalyst for decomposing nitrous oxide of the present invention can recover the activity through activation and regeneration even when deteriorated due to a volatile anesthetic contained in a waste anesthetic gas. Moreover, the catalyst for decomposing nitrous oxide of the present invention can decompose nitrous oxide at a relatively low temperature, is less deteriorated in the activity due to moisture even when moisture is present together, can control the amount of NOx generated to the allowable concentration or less and can reduce the amount of NOx generated to the level of about 1/10 to 1/100 as compared with conventional decomposition catalysts.

The catalyst for decomposing nitrous oxide of the present invention is characterized by containing as an essential component at least one noble metal selected from the group consisting of rhodium, ruthenium and palladium, and any one of the following catalysts (1) to (3) can be used.

(1) A catalyst obtained by loading at least one noble metal selected from the group (a) consisting of rhodium, ruthenium and palladium on a support selected from silica or silica alumina.

(2) A catalyst obtained by loading at least one noble metal selected from the group (a) consisting of rhodium, ruthenium and palladium, (b) aluminum and at least one metal selected from the group (c) consisting of zinc, iron and manganese on a silica support.

(3) A catalyst obtained by loading at least one noble metal selected from the group (a) consisting of rhodium, ruthenium and palladium and at least one metal selected from the group (d) consisting of magnesium, zinc, iron and manganese on a silica alumina support.

The support for use in the catalyst (1) is silica or silica alumina. A support having a surface area of approximately from 50 to 300 m²/g may be used, but it is not particularly limited to this range. The shape thereof is not particularly limited, according to the reactor or reaction method, a suitable shape may be selected, such as particle, powder or honeycomb.

The support for use in the catalyst (2) is silica. A support having a surface area of approximately from 50 to 300 m²/g may be used, but it is not particularly limited to this range. The shape thereof is also not particularly limited. According to the reactor or reaction method, a suitable shape may be selected, such as particle, powder or honeycomb.

Among the components supported on the silica support, at least one metal selected from the group (c) consisting of zinc, iron and manganese is preferably contained in an amount of 0.1 to 5.0% by mass, more preferably from 0.2 to 1.0% by mass, based on the entire mass of the catalyst. Even if the metal selected from the group (c) is contained in an amount of 5.0% by mass or more based on the entire mass of the catalyst, the effect is sometimes saturated.

The aluminum supported on the silica support is preferably contained in an atomic ratio of at least 2 or more to at least one metal selected from the group (c) consisting of zinc, iron and manganese. At least a part of aluminum preferably forms a spinel crystalline composite oxide with at least one metal selected from the group (c) and the spinel crystalline composite oxide can be produced by calcining the support having supported thereon, for example, aluminum and at least one metal selected from the group consisting of zinc, iron and manganese.

The spinel structure is a structure observed in oxides having a chemical formula of XY₂O₄ and belongs to a cubic system. With Zn, Fe or Mn, Al is known to form a spinel structure of ZnAl₂O₄, FeAl₂O₄ or MnAl₂O₄, respectively. Although the reasons are not clearly known, it is considered that at least a part of aluminum in the catalyst for decomposing nitrous oxide of the present invention forms a spinel crystalline composite oxide with a part or the whole of at least one metal selected from the group (c), whereby effects of enhancing the capability of decomposing nitrous oxide and at the same time, reducing the amount of NOx generated can be brought out.

The support for use in the catalyst (3) is silica alumina. A support having a surface area of approximately from 50 to 300 m²/g may be used, but it is not particularly limited to this range. At least one metal selected from the group (d) consisting of magnesium, zinc, iron and manganese, which is supported on the silica alumina support, is preferably contained in an amount of 0.1 to 5.0% by mass, more preferably from 0.2 to 1.0% by mass, based on the entire mass of the catalyst. Even if the metal selected from the group (d) is contained in an amount of 5.0% by mass or more based on the entire mass of the catalyst, the effect may be saturated.

The aluminum contained in the catalyst (3) is preferably contained in an atomic ratio of 2 or more to at least one metal selected from the group (d) consisting of magnesium, zinc, iron and manganese. Furthermore, at least a part of aluminum preferably forms a spinel crystalline composite oxide with at least one metal selected from the group (d). The spinel crystalline composite oxide can be produced by loading at least one metal selected from the group (d) on the silica alumina support and calcining the support.

Whichever catalyst (1), (2) or (3) is used, at least one noble metal selected from the group (a) consisting of rhodium, ruthenium and palladium, which is contained in the catalyst for decomposing nitrous oxide of the present invention, is preferably contained in an amount of 0.05 to 10% by mass, more preferably from 0.1 to 6.0% by mass, based on the entire mass of the catalyst. The catalytic activity at low temperatures may be improved by increasing the amount supported of at least one noble metal selected from the group (a), however, the amount supported in excess of 10% by mass is not preferred in view of the catalyst cost. On the other hand, if the amount supported is less than 0.05% by mass, the catalyst may fail in having a sufficiently high activity of decomposing nitrous oxide.

The process for producing the catalyst for decomposing nitrous oxide of the present invention is described below.

The catalyst for decomposing nitrous oxide of the present invention can be produced by various methods, for example, by the method such as (1) impregnation, (2) coprecipitation and (3) kneading.

The process for producing the catalyst (2) using the impregnation method is described below, however, needless to say, the present invention is not limited thereto.

The process for producing the catalyst (2) using the impregnation method can comprise the following three steps:

[1] a step of loading (b) aluminum and at least one metal selected from the group (c) consisting of zinc, iron and manganese on a silica support;

[2] a step of calcining the support obtained in the step [1] at 400 to 900° C.; and

[3] a step of loading at least one noble metal selected from the group (a) consisting of rhodium, ruthenium and palladium on the calcined support obtained in the step [2].

In the step [1], a silica support is impregnated with an inorganic acid salt of aluminum and an inorganic acid salt (e.g., nitrate, hydrochloride, sulfate) or organic acid salt (e.g., oxalate, acetate) of at least one metal selected from the group (c) consisting of zinc, iron and manganese. The salt of aluminum and the salt of at least one metal selected from the group (c) each is preferably nitrate.

Aluminum and at least one metal selected from the group (c) are preferably supported on a support such that aluminum is in an atomic ratio of 2 or more to at least one metal selected from the group (c) and also such that the amount supported of at least one metal selected from the group (c) is from 0.1 to 5.0% by mass based on the entire mass of the catalyst.

After performing the step [1], the support is preferably dried and by further performing the calcination step [2], a support-containing aluminum and at least one metal selected from the group (c) can be obtained, where at least a part of aluminum supported forms a spinel crystalline composite oxide with at least one metal selected from the group (c) consisting of zinc, iron and manganese. The temperature at the drying after the step [1] is not particularly limited but the temperature is preferably in the range from 80 to 150° C., more preferably from 100 to 130° C. Also, the drying atmosphere is not particularly limited but air is preferably used. The drying time is not particularly limited but, in the case of using the impregnation method, the drying time is usually from about 2 to 4 hours.

The calcination step [2] can be performed at a temperature in the range from 400 to 900° C., preferably from 500 to 700° C. If the calcination temperature is less than 400° C., the crystallization does not proceed sufficiently, whereas if it exceeds 900° C., the specific surface area of the support is disadvantageously liable to decrease. The calcination time is not particularly limited but is suitably on the order of 1 to 10 hours, preferably on the order of 2 to 4 hours. The calcination temperature may be changed stepwise. A long-term calcination operation is economically disadvantageous because the effect is sometimes saturated, whereas a short-time calcination operation cannot yield a sufficiently high effect. The calcination can be performed using a kiln or a muffle furnace and at this time, the flowing gas which can be used may be either nitrogen or air.

Then, the step [3] of loading a salt of at least one noble metal selected from the group (a) consisting of rhodium, ruthenium and palladium on the support obtained in the step [2] where at least a part of aluminum forms a spinel crystalline composite oxide with at least one metal selected from the group (c) consisting of zinc, iron and manganese, is performed. The salt of at least one noble metal selected from the group (a) is an inorganic acid salt (e.g., nitrate, hydrochloride, sulfate) or an organic acid salt (e.g., oxalate, acetate), and is preferably nitrate as an inorganic acid salt.

The step [3] is preferably performed on a support obtained in the step [2] where at least a part of aluminum forms a spinel crystalline composite oxide with at least one metal selected from the group (c), however, the step [3] may also be performed simultaneously with the step [1]. In this case, it is preferred to perform the step [1] and the step [3] simultaneously and then perform the step [2], so that at least a part of aluminum can form a spinel crystalline composite oxide with at least one metal selected from the group (c). In any case, the amount supported of at least one noble metal selected from the group (a) consisting of rhodium, ruthenium and palladium is preferably adjusted to 0.05 to 10% by mass based on the entire mass of the catalyst.

The catalyst precursor after the step [3] is then dried under the same drying conditions as above. The dried catalyst precursor is preferably subjected to a reduction treatment. By performing the reduction treatment, the obtained catalyst containing at least one noble metal selected from the group (a) can have high activity. The reduction treatment may be performed, for example, by (1) a method of reducing the catalyst precursor with hydrazine and again performing drying and then calcination or by (2) a method of performing hydrogen reduction. Among these, the method of performing hydrogen reduction is preferred. In the case of using the hydrogen reduction method, the reduction temperature is preferably from 200 to 500° C., more preferably from 300 to 400° C. The reducing time is not particularly limited but is suitably on the order of 1 to 10 hours, preferably on the order of 2 to 4 hours. The above-described dried catalyst precursor may be calcined in nitrogen or air without passing through the reduction treatment (1) or (2). At this time, the calcination temperature is preferably from 200 to 500° C., more preferably from 300 to 400° C.

The method for decomposing nitrous oxide using the above-described catalyst for decomposing nitrous oxide is described below. The method for decomposing nitrous oxide of the present invention includes the following four methods.

The method (1) for decomposing nitrous oxide of the present invention is characterized in that a nitrous oxide-containing gas is contacted with the above-described catalyst at a temperature of 200 to 600° C. The method (2) for decomposing nitrous oxide of the present invention is characterized in that the catalyst is a catalyst comprising a support having supported thereon at least one noble metal selected from the group consisting of rhodium, ruthenium and palladium and the support comprises silica or silica alumina and in that a nitrous oxide-containing gas is contacted with the catalyst at a temperature of 200 to 600° C., the feed of the nitrous oxide-containing gas is stopped on recognizing the reduction in activity of the catalyst in the decomposition process, the catalyst is activated and regenerated by heating at 500 to 900° C. and then, the feed of the nitrous oxide-containing gas is restarted.

The method (3) for decomposing nitrous oxide of the present invention is characterized in that the catalyst is a catalyst comprising a silica support having supported thereon at least one noble metal selected from the group (a) consisting of rhodium, ruthenium and palladium, (b) aluminum and at least one metal selected from the group (c) consisting of zinc, iron and manganese and in that a nitrous oxide-containing gas is contacted with the catalyst at a temperature of 200 to 600° C., the feed of the nitrous oxide-containing gas is stopped on recognizing the reduction in activity of the catalyst in the decomposition process, the catalyst is activated and regenerated by the heating at 500 to 900° C. and then, the feed of the nitrous oxide-containing gas is restarted.

The method (4) for decomposing nitrous oxide of the present invention is characterized in that the catalyst is a catalyst comprising a silica alumina support having supported thereon at least one noble metal selected from the group (a) consisting of rhodium, ruthenium and palladium and at least one metal selected from the group (d) consisting of magnesium, zinc, iron and manganese and in that a nitrous oxide-containing gas is contacted with the catalyst at 200 to 600° C., the feed of the nitrous oxide-containing gas is stopped on recognizing the reduction in activity of the catalyst in the decomposition process, the catalyst is activated and regenerated by the heating at 500 to 900° C. and then, the feed of the nitrous oxide-containing gas is restarted.

In the method for decomposing nitrous oxide of the present invention, the nitrous oxide-containing gas is suitably contacted with the decomposition catalyst at a temperature of 200 to 600° C., preferably from 300 to 500° C., more preferably from 350 to 450° C. If the contact temperature is less than 200° C., the decomposition of nitrous oxide may not proceed satisfactorily, whereas if it exceeds 600° C., the catalyst is disadvantageously liable to have a shortened life. The catalyst bed system is not particularly limited but a fixed bed can be preferably used.

As for the composition of the nitrous oxide-containing gas, the concentration of nitrous oxide contained in an exhaust gas discharged from factories or incineration facilities is usually 1,000 ppm or less, however, the concentration of nitrous oxide discharged from an operating room by a waste anesthetic gas-removing apparatus is very high and approximately from 8 to 50%. In the waste anesthetic gas, oxygen is usually present in a concentration of 13 to 20% and therefore, the decomposition catalyst is laid under severe conditions, and preferably heat may be removed. As long as the temperature can be controlled, the concentration of nitrous oxide contacted with the decomposition catalyst is not particularly limited, however, since the reaction of decomposing nitrous oxide into nitrogen and oxygen is an exothermic reaction, the concentration of nitrous oxide is suitably 50% or less, preferably 25% or less, more preferably about 5%. The space velocity indicating the amount of gas fed per unit catalyst is preferably from 10 to 20,000 Hr⁻¹, more preferably from 100 to 10,000 Hr⁻¹.

The nitrous oxide-containing gas sometimes contains a volatile anesthetic, however, the catalyst for decomposing nitrous oxide of the present invention is not easily poisoned by the volatile anesthetic. Moreover, even when the catalyst is poisoned by the volatile anesthetic and reduced in the activity, the catalytic activity can be recovered by using the decomposition method of the present invention, so that the decomposition of nitrous oxide can be performed over a long period of time. Accordingly, when the decrease in activity of the catalyst for decomposing nitrous oxide is recognized, the feed of the nitrous oxide-containing gas is once stopped and after the catalyst is activated and regenerated by performing a calcination treatment, the feed of the nitrous oxide-containing gas can be restarted.

In the calcination treatment for activating and regenerating the catalyst, the decomposition catalyst reduced in the activity can be calcined at temperature of 500 to 900° C., preferably from 600 to 800° C., more preferably from 650 to 750° C. During the calcination treatment, an inert gas such as helium and nitrogen or an air can be flowed into the catalyst layer and oxygen may be contained in the inert gas. An air is preferably used because this is simple and convenient. The calcination treatment time is suitably on the order of from 10 minutes to 12 hours, preferably from 20 minutes to 6 hours, more preferably from 30 minutes to 2 hours. Among the above-described catalysts where at least one noble metal selected from the group (a) consisting of rhodium, ruthenium and palladium is supported, the catalyst containing ruthenium is less poisoned by the volatile anesthetic and easier to recover the catalytic activity. The activity is liable to lower in the order of rhodium and palladium. Accordingly, at least ruthenium is preferably used as the noble metal component selected from the group (a). After the calcination treatment, a reduction treatment with hydrogen may also be performed.

The catalyst for use in the decomposition method (3) of the present invention preferably contains, out of the components supported on the silica support, at least one metal selected from the group (c) consisting of zinc, iron and manganese in an amount of 0.1 to 5.0% by mass, more preferably from 0.2 to 1.0% by mass, based on the entire mass of the catalyst. Even if the metal selected from the group (c) is contained in an amount of 5.0% by mass or more based on the entire mass of the catalyst, the effect is sometimes saturated.

The aluminum supported on the silica support is preferably contained in an atomic ratio of at least 2 or more to at least one metal selected from the group (c) consisting of zinc, iron and manganese. Furthermore, at least a part of aluminum preferably forms a spinel crystalline composite oxide with at least one metal selected from the group (c) and the spinel crystalline composite oxide can be produced, for example, by calcining the support having supported thereon aluminum and at least one metal selected from the group consisting of zinc, iron and manganese.

The catalyst for use in the decomposition method (4) preferably contains at least one metal selected from the group (d) consisting of magnesium, zinc, iron and manganese, which is supported on a silica alumina support, in an amount of 0.1 to 5.0% by mass, more preferably from 0.2 to 1.0% by mass, based on the entire mass of the catalyst. Even if the metal selected from the group (d) is contained in an amount of 5.0% by mass or more based on the entire mass of the catalyst, the effect is sometimes saturated.

The aluminum is preferably contained in an atomic ratio of at least 2 or more to at least one metal selected from the group (d) consisting of magnesium, zinc, iron and manganese. Furthermore, at least a part of aluminum preferably forms a spinel crystalline composite oxide with at least one metal selected from the group (d). The spinel crystalline composite oxide can be produced by loading at least one metal selected from the group (d) on the silica alumina support and calcining the support.

Whichever decomposition method (1), (2), (3) or (4) is used, at least one noble metal selected from the group (a) consisting of rhodium, ruthenium and palladium, which is contained in the catalyst used in the method for decomposing nitrous oxide of the present invention, is preferably contained in an amount of 0.05 to 10% by mass, more preferably from 0.1 to 6.0% by mass, based on the entire mass of the catalyst. By increasing the supported amount of at least one noble metal selected from the group (a), the catalytic activity at low temperatures may be improved, however, the amount supported in excess of 10% by mass or more is not preferred in view of the catalyst cost and if the amount supported is less than 0.05% by mass, the catalyst may fail in having a sufficiently high activity of decomposing nitrous oxide.

### BEST MODE FOR CARRYING OUT THE INVENTION

The present invention is described in greater detail below by referring to Examples and Comparative Examples, however, the present invention should not be construed as being limited thereto.

### EXAMPLE 1

### Preparation of Catalyst

With 1.84 g of distilled water, 1.32 g of a 21.4% rhodium nitrate solution (Rh(NO₃)₃ aq.) was mixed. Thereto, 2.04 g of silica support (JRC-SIO-4, see Nippon Shokubai Gakkai, Shokubai (Catalyst)) was added and after the entire amount was impregnated, the support was dried up in a hot bath at 90° C. The obtained support was dried in air at 110° C. for 12 hours and then subjected to a calcination treatment at 650° C. for 2 hours to obtain a catalyst 1 where 5% by mass of rhodium (Rh) was supported on a silica support.

### EXAMPLE 2

### Preparation of Catalyst

A catalyst 2 was prepared in the same manner as in Example 1 except for using 0.99 g of a 31.4% ruthenium nitrosyl nitrate solution (Ru(NO)(NO₃)₃ aq.). In the catalyst 2 obtained, 5% by mass of ruthenium (Ru) was supported on the silica support.

### EXAMPLE 3

### Preparation of Catalyst

A catalyst 3 was prepared in the same manner as in Example 1 except for using 0.43 g of a 52.2% palladium nitrate solution (Pd(NO₃)₃ aq.). In the catalyst 3 obtained, 5% by mass of palladium (Pd) was supported on the silica support.

### EXAMPLE 4

### Preparation of Catalyst

In 4.94 g of distilled water, 0.208 g of zinc nitrate (Zn(NO₃)₂.6H₂O) and 0.54 g of aluminum nitrate (Al(NO₃)₃.9H₂O) were dissolved. Thereto, 4.00 g of a silica support was added and after the entire amount was impregnated, the support was dried up in a hot bath at 90° C. The obtained support was dried in air at 120° C. for 12 hours and subsequently calcined in a muffle furnace at 650° C. for 3 hours in an air stream to obtain a spinel crystalline composite oxide silica catalyst precursor where a spinel crystalline composite oxide was supported. With 2.35 g of distilled water, 2.59 g of a 21.4% rhodium nitrate solution (Rh(NO₃)₃ aq.) was mixed. Thereto, the spinel crystalline composite oxide silica catalyst precursor was added and after the entire amount was impregnated, the support was dried up in a hot bath at 90° C. The obtained support was dried in air at 120° C. for 12 hours and then subjected to a hydrogen reduction at 400° C. for 3 hours to obtain a silica catalyst having supported thereon 5% by mass of Rh/ZnAl₂O₄ (catalyst 4).

### EXAMPLE 5

### Preparation of Catalyst

A silica catalyst having supported thereon 5% by mass of Rh/MnAl₂O₄ (catalyst 5) was obtained in the same manner as in Example 4 except for 0.195 g of manganese nitrate (Mn(NO₃)₂.6H₂O) in place of zinc nitrate.

### EXAMPLE 6

### Preparation of Catalyst

A silica catalyst having supported thereon 5% by mass of Rh/FeAl₂O₄ (catalyst 6) was obtained in the same manner as in Example 4 except for using 0.16 g of iron nitrate (Fe(NO₃)₂.9H₂O) in place of zinc nitrate.

### EXAMPLE 7

### Preparation of Catalyst

A silica alumina catalyst having supported thereon 5% by mass of Rh/ZnAl₂O₄ (catalyst 7) was obtained in the same manner as in Example 4 except for using 4.0 g of silica alumina support in place of silica support.

### COMPARATIVE EXAMPLE 1

A comparative catalyst 1 was prepared in the same manner as in Example 1 except for mixing 2.18 g of distilled water with 1.32 g of a 21.4% rhodium nitrate solution (Rh(NO₃)₃ aq.) and using 2.04 g of alumina support. In the comparative catalyst 1 obtained, 5% by mass of Rh was supported on the alumina support.

### COMPARATIVE EXAMPLE 2

A comparative catalyst 2 was prepared in the same manner as in Example 1 except for adding 2.04 g of a zirconia support to 1.32 g of a 21.4% rhodium nitrate solution (Rh(NO₃)₃ aq.) and impregnating the entire amount. In the comparative catalyst 2 obtained, 5% by mass of Rh was supported on the zirconia support.

### REACTION EXAMPLE 1

### Decomposition Test of Nitrous Oxide

The catalyst 1 obtained in Example 1 was graded to 42 to 80 mesh and then, filled in a quartz-made reaction tube to prepare a reactor. This reactor was placed in an electric furnace and by setting the reaction temperature to 200 to 500° C., a reaction gas having a gas composition of N₂O/O₂/He=5/5/90 (vol %) was fed at a space velocity of 10,000 Hr⁻¹. The amount of nitrous oxide was analyzed by gas chromatography at the inlet and outlet of the reactor.

After the evaluation of activity, a gas of isoflurane/Air=1/99 (vol %) was passed through under deterioration conditions of 300° C. for 0.5 Hr and then, the activity of the catalyst was again evaluated in the same manner.

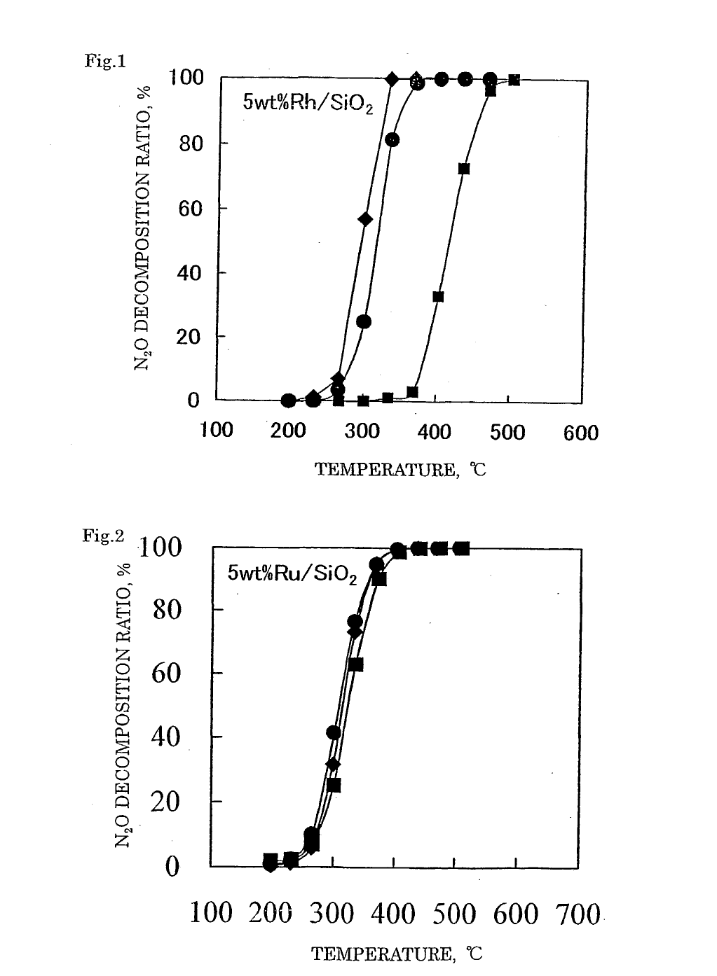

For regenerating this deteriorated catalyst, a sintering treatment was performed at 700° C. for 0.5 Hr while passing 20% O₂/He and the activity was evaluated in the same manner. The results are shown in Table 1 and FIG. 1. In Table 1, a temperature (T₅₀) where the decomposition ratio of nitrous oxide reached 50% is shown. In FIG. 1, the mark ♦ shows the decomposition results of nitrous oxide before the deterioration of catalyst, the mark ▪ shows the decomposition results of nitrous oxide after the deterioration of catalyst, and the mark ● shows the decomposition results of nitrous oxide after the regeneration of catalyst. It is seen from the results shown in FIG. 1 that the activity of the catalyst 1 is recovered by the regeneration treatment. The total concentration of nitrogen dioxide and nitrogen monoxide was measured at 350° C. by a detector tube and found to be 1.0 ppm.

### REACTION EXAMPLE 2

### Decomposition Test of Nitrous Oxide

An evaluation was performed in the same manner as in Reaction Example 1 except for using the catalyst 2 obtained in Example 2. The results obtained are shown in Table 1 and FIG. 2 (the numerical value in Table and the marks in Figure have the same meanings as in Reaction Example 1). It is seen from the results shown in FIG. 2 that the activity of the catalyst 2 is recovered by the regeneration treatment. The total concentration of nitrogen dioxide and nitrogen monoxide at 350° C. was found to be 0.8 ppm.

### REACTION EXAMPLE 3

### Decomposition Test 3 of Nitrous Oxide

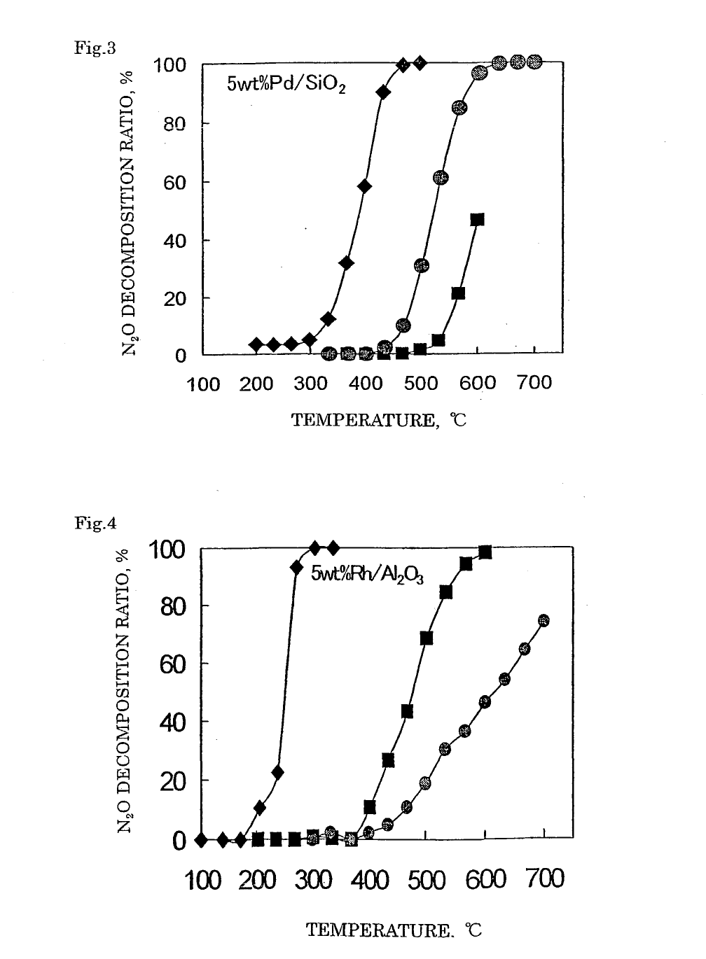

An evaluation was performed in the same manner as in Reaction Example 1 except for using the catalyst 3 obtained in Example 3 and the results are shown in Table 1 and FIG. 3 (the numerical value in Table and the marks in Figure have the same meanings as in Reaction Example 1). It is seen from the results shown in FIG. 3 that the activity of the catalyst 3 is recovered by the regeneration treatment. The total concentration of nitrogen dioxide and nitrogen monoxide at 350° C. was found to be 0.1 ppm.

### COMPARATIVE REACTION EXAMPLE 1

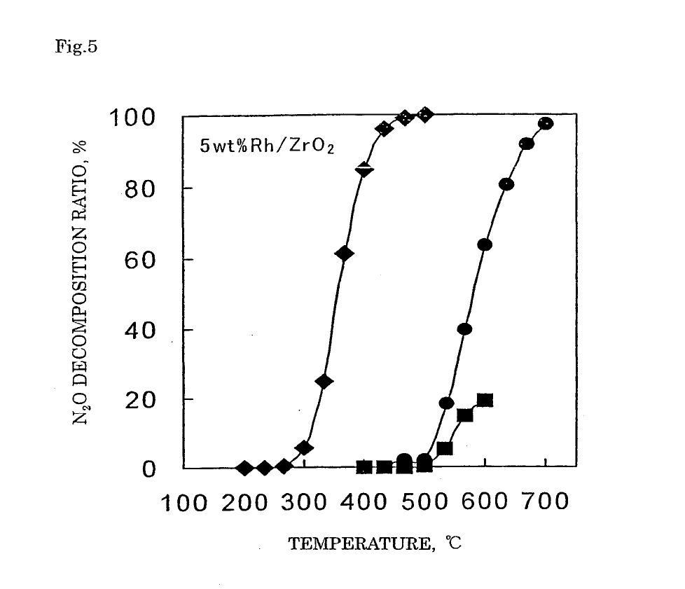

An evaluation was performed in the same manner as in Reaction Example 1 except for using the comparative catalyst 1 obtained in Comparative Example 1 and the results are shown in Table 1 and FIG. 4 (the numerical value in Table and the marks in Figure have the same meanings as in Reaction Example 1). It is seen from the results shown in FIG. 4 that the activity of the comparative catalyst 1 is not recovered by the regeneration treatment. The total concentration of nitrogen dioxide and nitrogen monoxide at 350° C. was found to be 4.0 ppm.

### COMPARATIVE REACTION EXAMPLE 2

An evaluation was performed in the same manner as in Reaction Example 1 except for using the comparative catalyst 2 obtained in Comparative Example 2 and the results are shown in Table 1 and FIG. 5 (the numerical value in Table and the marks in Figure have the same meanings as in Reaction Example 1). It is seen from the results shown in FIG. 5 that the activity of the comparative catalyst 2 is not recovered by the regeneration treatment. The total concentration of nitrogen dioxide and nitrogen monoxide at 350° C. was found to be 4.5 ppm.

### REACTION EXAMPLE 4

### Decomposition Test of Nitrous Oxide

An evaluation was performed in the same manner as in Reaction Example 1 except for using the catalyst 4 obtained in Example 4 and the results are shown in Table 1 (the numerical value in Table has the same meaning as in Reaction Example 1). The total concentration of nitrogen dioxide and nitrogen monoxide at 350° C. was found to be 1.5 ppm.

### REACTION EXAMPLE 5

### Decomposition Test of Nitrous Oxide

An evaluation was performed in the same manner as in Reaction Example 1 except for using the catalyst 5 obtained in Example 5 and the results are shown in Table 1 (the numerical value in Table has the same meaning as in Reaction Example 1). The total concentration of nitrogen dioxide and nitrogen monoxide at 350° C. was found to be 1.0 ppm.

### REACTION EXAMPLE 6

### Decomposition Test of Nitrous Oxide

An evaluation was performed in the same manner as in Reaction Example 1 except for using the catalyst 6 obtained in Example 6 and the results are shown in Table 1 (the numerical value in Table has the same meaning as in Reaction Example 1). The total concentration of nitrogen dioxide and nitrogen monoxide at 350° C. was found to be 1.3 ppm.

### REACTION EXAMPLE 7

### Decomposition Test of Nitrous Oxide

An evaluation was performed in the same manner as in Reaction Example 1 except for using the catalyst 7 obtained in Example 7 and the results are shown in Table 1 (the numerical value in Table has the same meaning as in Reaction Example 1). The total concentration of nitrogen dioxide and nitrogen monoxide at 350° C. was found to be 1.2 ppm.

TABLE 1

| | Temperature When Nitrous Oxide | | | |
|---|---|---|---|---|
| | Decomposition Ratio T₅₀ (° C.) | | | NOₓ at |
| | Before | After | After | 350° C. |
| Catalyst | Deterioration | Deterioration | Regeneration | (ppm) |
| Reaction | 291 | 426 | 316 | 1.0 |
| Example 1 | | | | |
| Reaction | 333 | 600 | 508 | 0.8 |
| Example 2 | | | | |
| Reaction | 306 | 313 | 322 | 0.1 |
| Example 3 | | | | |
| Reaction | 303 | 442 | 328 | 1.5 |
| Example 4 | | | | |
| Reaction | 306 | 450 | 332 | 1.0 |
| Example 5 | | | | |
| Reaction | 300 | 440 | 335 | 1.3 |
| Example 6 | | | | |
| Reaction | 325 | 485 | 365 | 1.2 |
| Example 7 | | | | |
| Comparative | 250 | 475 | 620 | 4.0 |
| Reaction | | | | |
| Example 1 | | | | |
| Comparative | 360 | >600 | 585 | 4.5 |
| Reaction | | | | |
| Example 2 | | | | |

Reaction conditions:
N₂O/O₂/He = 5/5/90, SV: 10,000 Hr⁻¹
Deterioration conditions:
isoflurane/air = 1/99, 300° C., 0.5 Hr

### INDUSTRIAL APPLICABILITY

In the present invention, a catalyst comprising a 5 silica or silica alumina support having supported thereon at least one noble metal selected from the group (a) consisting of rhodium, ruthenium and palladium, a catalyst comprising a silica support having supported thereon aluminum, at least one metal selected from the group (c) consisting of zinc, iron and manganese and further at least one noble metal selected from the group (a), or a catalyst comprising a silica alumina support having supported thereon at least one metal selected from the group (d) consisting of magnesium, zinc, iron and manganese and further at least one noble metal selected from the group (a) is used. As a result thereof, these catalysts are not easily poisoned by a volatile anesthetic contained in a waste anesthetic gas. Even when the catalytic activity is decreased by the volatile anesthetic, these catalysts can be activated and regenerated, so that the decomposing treatment of nitrous oxide can be performed over a long period of time.

At the same time, the amount of NOx generated during the decomposition of nitrous oxide can be reduced.

1. A catalyst for decomposing nitrous oxide, comprising a support and supported thereon at least one noble metal selected from the group consisting of rhodium, ruthenium and palladium, said support comprising silica or silica alumina.

2. A catalyst for decomposing nitrous oxide, comprising a support and supported thereon:
(a) at least one noble metal selected from the group consisting of rhodium, ruthenium and palladium,
(b) aluminum, and
(c) at least one metal selected from the group consisting of zinc, iron and manganese,
said support comprising silica.

3. The catalyst for decomposing nitrous oxide as claimed in claim 2, wherein at least one metal selected from the group (c) consisting of zinc, iron and manganese is contained in an amount of 0.1 to 5.0% by mass based on the entire mass of the catalyst.

4. The catalyst for decomposing nitrous oxide as claimed in claim 2, wherein aluminum is contained in an atomic ratio of 2 or more to at least one metal selected from the group (c) consisting of zinc, iron and manganese.

5. The catalyst for decomposing nitrous oxide as claimed in claim 2 or 4, wherein at least a part of aluminum forms a spinel crystalline composite oxide with at least one metal selected from the group (c) consisting of zinc, iron and manganese.

6. A catalyst for decomposing nitrous oxide, comprising a support and supported thereon:
(a) at least one noble metal selected from the group consisting of rhodium, ruthenium and palladium, and
(d) at least one metal selected from the group consisting of magnesium, zinc, iron and manganese,
said support comprising silica alumina.

7. The catalyst for decomposing nitrous oxide as claimed in claim 6, wherein at least one metal selected from the group (d) consisting of magnesium, zinc, iron and manganese is contained in an amount of 0.1 to 5.0% by mass based on the entire mass of the catalyst.

8. The catalyst for decomposing nitrous oxide as claimed in claim 6, wherein aluminum is contained in an atomic ratio of 2 or more to at least one metal selected from the group (d) consisting of magnesium, zinc, iron and manganese.

9. The catalyst for decomposing nitrous oxide as claimed in claim 6 or 8, wherein at least a part of aluminum forms a spinel crystalline composite oxide with at least one metal selected from the group (d) consisting of magnesium, zinc, iron and manganese.

10. The catalyst for decomposing nitrous oxide as claimed in any one of claims 1,2 or 6, wherein said noble metal is contained in an amount of 0.05 to 10% by mass based on the entire mass of the catalyst.

11. A process for producing a catalyst for decomposing nitrous oxide, comprising the following three steps:
(1) a step of loading aluminum (b) and at least one metal selected from the group (c) consisting of zinc, iron and manganese on a support comprising silica;
(2) a step of calcining the support obtained in the step (1) at 400 to 900° C.; and
(3) a step of loading at least one noble metal selected from the group (a) consisting of rhodium, ruthenium and palladium on the calcined support obtained in the step (2).

12. A process for producing a catalyst for decomposing nitrous oxide, comprising the following three steps:
(1) a step of loading at least one metal selected from the group (d) consisting of magnesium, zinc, iron and manganese on a support comprising silica alumina;
(2) a step of calcining the support obtained in the step (1) at 400 to 900° C.; and
(3) a step of loading at least one noble metal selected from the group (a) consisting of rhodium, ruthenium and palladium on the calcined support obtained in the step (2).

13. A method for decomposing nitrous oxide, comprising contacting the catalyst for decomposing nitrous oxide claimed in any one of claims 1,2 or 6 with a nitrous oxide-containing gas at 200 to 600° C.

14. A method for decomposing nitrous oxide, comprising decomposing nitrous oxide using a catalyst, wherein the catalyst is a catalyst comprising a support and supported thereon at least one noble metal selected from the group consisting of rhodium, ruthenium and palladium and the support comprises silica or silica alumina and wherein a nitrous oxide-containing gas is contacted with said catalyst at 200 to 600° C., the feeding of nitrous oxide-containing gas is stopped on recognizing the reduction in activity of the catalyst in the decomposition process, the catalyst is activated and regenerated by heating at 500 to 900° C. and then the feeding of nitrous oxide-containing gas is restarted.

15. A method for decomposing nitrous oxide, comprising decomposing nitrous oxide using a catalyst, wherein the catalyst is a catalyst comprising a support and supported thereon:
(a) at least one noble metal selected from the group consisting of rhodium, ruthenium and palladium,
(b) aluminum, and
(c) at least one metal selected from the group consisting of zinc, iron and manganese,
and the support is silica and wherein a nitrous oxide-containing gas is contacted with said catalyst at 200 to 600° C., the feeding of nitrous oxide-containing gas is stopped on recognizing the reduction in activity of the catalyst in the decomposition process, the catalyst is activated and regenerated by heating at 500 to 900° C. and then the feeding of nitrous oxide-containing gas is restarted.

16. The method for decomposing nitrous oxide as claimed in claim 15, wherein said catalyst contains at least one metal selected from the group (c) consisting of zinc, iron and manganese in an amount of 0.1 to 5.0% by mass based on the entire mass of the catalyst.

17. The method for decomposing nitrous oxide as claimed in claim 15, wherein said catalyst contains aluminum in an atomic ratio of 2 or more to at least one metal selected from the group (c) consisting of zinc, iron and manganese.

18. The method for decomposing nitrous oxide as claimed in claim 15 or 17, wherein at least a part of aluminum contained in said catalyst forms a spinel crystalline composite oxide with at least one metal selected from the group (c) consisting of zinc, iron and manganese.

19. A method for decomposing nitrous oxide, comprising decomposing nitrous oxide using a catalyst, wherein the catalyst is a catalyst comprising a support and supported thereon:
(a) at least one noble metal selected from the group consisting of rhodium, ruthenium and palladium, and
(d) at least one metal selected from the group consisting of magnesium, zinc, iron and manganese,
and the support is silica alumina and wherein a nitrous oxide-containing gas is contacted with said catalyst at 200 to 600° C., the feeding of nitrous oxide-containing gas is stopped on recognizing the reduction in activity of the catalyst in the decomposition process, the catalyst is activated and regenerated by heating at 500 to 900° C. and then the feeding of nitrous oxide-containing gas is restarted.

20. The method for decomposing nitrous oxide as claimed in claim 19, wherein said catalyst contains at least one metal selected from the group (d) consisting of magnesium, zinc, iron and manganese in an amount of 0.1 to 5.0% by mass based on the entire mass of the catalyst.

21. The method for decomposing nitrous oxide as claimed in claim 19, wherein said catalyst contains aluminum in an atomic ratio of 2 or more to at least one metal selected from the group (d) consisting of magnesium, zinc, iron and manganese.

22. The method for decomposing nitrous oxide as claimed in claim 19 or 21, wherein at least a part of aluminum contained in said catalyst forms a spinel crystalline composite oxide with at least one metal selected from the group (d) consisting of magnesium, zinc, iron and manganese.

23. The method for decomposing nitrous oxide as claimed in any one of claims 14,15 or 19, wherein said catalyst contains said noble metal in an amount of 0.05 to 10% by mass based on the entire mass of the catalyst.

24. The method for decomposing nitrous oxide as claimed in any one of claims 14,15 or 19, wherein said nitrous oxide-containing gas-contains a volatile anesthetic.
